(19) United States
(12) Patent Application Publication
(10) Pub. No.: US 2008/0120647 A1
(43) Pub. Date: May 22, 2008

(54) Audio/video apparatus and display method for audio/video apparatus

(75) Inventor: Suk-young Shin, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/790,370

(22) Filed: Apr. 25, 2007

(30) Foreign Application Priority Data
Nov. 20, 2006 (KR) 2006-114350

(51) Int. Cl. H04N 5/445

(52) U.S. Cl. 725/37

(57) ABSTRACT

An audio/video (A/V) apparatus and a display method for the A/V apparatus are provided. The A/V apparatus includes a graphical user interface (GUI) for displaying display information on a screen, and a controller for controlling the GUI to display a second graphic, which is generated by zooming a partial interval of a first graphic indicating a current playback position, as the display information. Accordingly, the zoom-in bar is provided so that a user may move the position of the content currently being played back to the desired position more accurately and quickly, and may perform fine adjustment with convenience using the zoom-in function.

### CROSS-REFERENCE TO RELATED APPLICATIONS

This application claims the benefit under 35 U.S.C. § 119(a) of Korean Patent Application No. 10-2006-0114350, filed on Nov. 20, 2006, in the Korean Intellectual Property Office, the entire disclosure of which is hereby incorporated by reference.

### BACKGROUND OF THE INVENTION

1. Field of the Invention

The present invention relates to an audio/video (A/V) apparatus and a display method for an A/V apparatus. More particularly, the present invention relates to an A/V apparatus and a display method for an A/V apparatus that provides a zoom-in bar containing fine adjustment intervals obtained by dividing a reference interval displayed on a navigation bar by a predetermined ratio.

2. Description of the Related Art

Generally, broadcast receiving apparatuses are a sort of audio/video (A/V) apparatus that receives digital satellite broadcasting. Broadcast receiving apparatuses convert digital broadcasting or analog broadcasting transmitted from broadcasting stations, and video and audio signals received from various external apparatuses (for example, video players, digital video disk (DVD) players, or other apparatuses) into transport stream (TS) signals. The converted signals are transmitted to display devices. Set-top boxes are used as broadcast receiving apparatuses. The term set-top box describes a device that connects to a television and some external source of a signal.

Set-top boxes turn the signal into content that is then displayed on the screen. The signal source can be an ethernet cable, a satellite dish, a coaxial cable, a television line, or even an ordinary very high frequency or ultra high frequency antenna. Content, in this case, can be any or all of video, audio, Internet webpages, interactive games, and other material.

When playing back content on a conventional A/V apparatus, a navigation bar is displayed on the screen displaying the content. On the navigation bar, the position of the content currently being played back relative to the total length of the content available for playing back is displayed. The navigation bar of the conventional A/V apparatus is shown in FIG. 1.

To change the position of the content currently being played back, the user may operate direction buttons to set the current playback position displayed on the navigation bar to the desired position. In other words, when a user operates control buttons, such as fast forward, rewind, skip, or other buttons, the position of the content currently being played back may be set to the desired position.

When a user controls the position of the content using the skip button in the conventional A/V apparatus, the position may move to a position adjacent to the desired position, but it is difficult to instantly move the current position to the exact position desired. Accordingly, a long period of time corresponding to one interval is required in the case of large capacity content, and thus, it is more difficult to set the current position of the content to the desired position.

Accordingly, a need exists for an apparatus for and method of accurately and quickly moving the desired playback position of an audio/video apparatus.

### SUMMARY OF THE INVENTION

Accordingly, an exemplary aspect of the present invention is to provide an audio/video (A/V) apparatus and a display method for the A/V apparatusthat provide a zoom-in bar for dividing a reference interval into fine adjustment intervals, and for magnifying the fine adjustment intervals so that a user may more accurately move the position of content currently being played back to the desired position.

The foregoing and other objects and advantages are substantially realized by providing an A/V apparatus that comprises a graphical user interface (GUI) for displaying display information on a screen, and a controller for controlling the GUI to display a second graphic, which is generated by zooming a partial interval of a first graphic indicating a current playback position, as the display information.

The controller may control the GUI to display the first graphic together with the second graphic as the display information.

The controller may determine fine adjustment intervals based on a reference interval corresponding to a set magnification scale, and control the GUI to show the fine adjustment intervals as display information.

Additionally, the controller may set a reference interval differently according to the magnification scale and determine fine adjustment intervals based on the set reference interval.

The controller may determine whether the magnification scale is set to the fixed scale when a magnification command is input through a remote control device. The controller may set a reference interval corresponding to the fixed scale by dividing a reference interval corresponding to a scale of 1:1 using the fixed scale, and determine fine adjustment intervals based on the set reference interval, when it is determined that the magnification scale is set to the fixed scale.

The controller may determine fine adjustment intervals using a preset reference interval corresponding to an automatic scale, when it is determined that the magnification scale is set to the automatic scale.

The controller may divide the set reference interval by a preset interval adjustment value to determine fine adjustment intervals when it is determined that the magnification scale is set to the fixed scale, and may divide the reference interval corresponding to the automatic scale by the interval adjustment value to determine fine adjustment intervals when it is determined that the magnification scale is set to the automatic scale.

The reference interval may contain a previous interval and a next interval within a predetermined range from the position of the content currently being played back.

The controller may control the GUI so that the reference interval is magnified to show a plurality of fine adjustment intervals as display information.

According to another aspect of exemplary embodiments of the present invention, a display method for an A/V apparatus is provided that comprises displaying display information on a screen, and displaying a second graphic, which is generated by zooming a partial interval of a first graphic indicating a current playback position, as the display information.

The displaying the second graphic may comprise displaying the first graphic together with second graphic as the display information.

The displaying the second graphic may comprise determining fine adjustment intervals based on a reference interval corresponding to a set magnification scale, and showing the fine adjustment intervals as display information.

Additionally, the displaying the second graphic may comprise setting a reference interval differently according to the magnification scale and determining the fine adjustment intervals based on the set reference interval.

The displaying the second graphic may comprise determining whether the magnification scale is set to the fixed scale when a magnification command is input through a remote control device. A reference interval corresponding to the fixed scale is set by dividing a reference interval corresponding to a scale of 1:1 using the fixed scale, and determining fine adjustment intervals based on the set reference interval when it is determined that the magnification scale is set to the fixed scale. The fine adjustment intervals are determined using a preset reference interval corresponding to an automatic scale when it is determined that the magnification scale is set to the automatic scale.

The determining the fine adjustment intervals may comprise dividing the set reference interval by a preset interval adjustment value to determine fine adjustment intervals when it is determined that the magnification scale is set to the fixed scale. The reference interval corresponding to the automatic scale is divided by the interval adjustment value to determine fine adjustment intervals when it is determined that the magnification scale is set to the automatic scale.

The reference interval may contain a previous interval and a next interval within a predetermined range from the position of the content currently being played back.

The displaying the second graphic may comprise magnifying the reference interval to show a plurality of fine adjustment intervals as display information.

Other objects, advantages and salient features of the invention will become apparent from the following detailed description, which, taken in conjunction with the annexed drawings, discloses exemplary embodiments of the invention.

### BRIEF DESCRIPTION OF THE DRAWINGS

The above aspects and features of the present invention will be more apparent by describing certain exemplary embodiments of the present invention with reference to the accompanying drawings, in which:

FIG. 1 is an exemplary view illustrating a navigation bar provided in a conventional A/V apparatus;

FIG. 2 is a block diagram of an A/V apparatus according to an exemplary embodiment of the present invention;

FIG. 3 is a flowchart explaining a method for operating an A/V apparatus according to an exemplary embodiment of the present invention; and

FIG. 4 is an exemplary view illustrating a zoom-in bar provided in an A/V apparatus according to exemplary embodiments of the present invention.

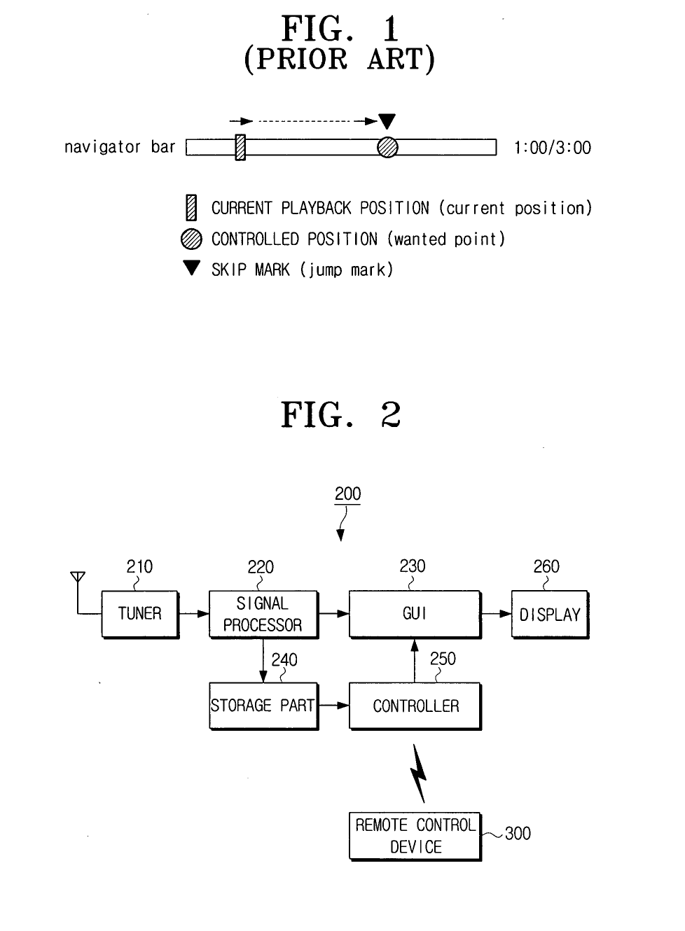

Throughout the drawings, like reference numerals are understood to refer to like parts, components and structures.

### DETAILED DESCRIPTION OF EXEMPLARY EMBODIMENTS

Certain exemplary embodiments of the present invention are described below in greater detail with reference to the accompanying drawings.

The matters defined in the description, such as a detailed construction and elements thereof, are provided to assist in a comprehensive understanding of the embodiments of the invention and are merely exemplary. Accordingly, those of ordinary skill in the art will recognize that various changes and modifications of the exemplary embodiments described herein can be made without departing from the scope and spirit of the invention. Descriptions of well-known functions and constructions are omitted for clarity and conciseness.

FIG. 2 is a block diagram of an A/V apparatus according to an exemplary embodiment of the present invention. In FIG. 2, the A/V apparatus 200 comprises a tuner 210, a signal processor 220, a graphical user interface (GUI) 230, a storage part 240, and a controller 250.

The tuner 210 receives a broadcasting signal corresponding to a channel selected by a user from a broadcasting station, and tunes to the channel.

The signal processor 220 processes various broadcasting signals output from the tuner 210, separates the signals into a video signal, an audio signal, and a data signal, and performs image processing so that the image may be displayed.

The GUI 230 enables a user to interact with the A/V apparatus 200, and generates a PARC user interface (PUI) corresponding to user commands received through a manipulation part (not illustrated) or a remote control device 300 and a GUI corresponding to user commands input through a selection from icons or menus displayed on a display part 260. Next, the GUI 230 displays the generated PUI and GUI on the display part 260. The remote control device 300 may be a remote controller, but is not necessarily limited thereto.

The GUI 230 combines display information, such as characters, symbols, diagrams, or graphics, with the image output from the signal processor 220 or the content read from the storage part 240. The GUI 230 may combine the display information using an on screen display (OSD) method, but the method is not necessarily limited thereto. The operation of combining the display information of the GUI 230 may be controlled by the controller 250.

Specifically, the GUI 230 combines the display information with the image output from the signal processor 220, and displays the combined information on the display part 260. The GUI 230 displays a navigation bar and a zoom-in bar as display information under the control of the controller 250. The navigation bar and zoom-in bar may be placed on the bottom of the screen displaying the image, and the zoom-in bar may be placed above the navigation bar, but the present invention is not necessarily limited in this manner.

The navigation bar identifies the position of content currently being played back on the display part 260, and the zoom-in bar identifies the magnification of fine adjustment intervals obtained by dividing a reference interval on the navigation bar by a preset interval adjustment value. The GUI 230 displays the zoom-in bar, in which the characters, symbols and diagrams are combined with the graphics indicating the position of content being played back, as display information on the display part 260.

The storage part 240 stores various programs and content required to control the A/V apparatus 200. The content, in this case, may mean any or all of video, audio, Internet webpages, interactive games, and other material.

When a magnification command is input through the remote control device 300 or the manipulation part (not illustrated) included in the A/V apparatus 200, the controller 250 may determine whether the magnification scale is set to the fixed scale. When it is determined that the magnification scale is set to the fixed scale, the controller 250 may set a reference interval corresponding to the fixed scale, such as 2:1, 4:1, 6:1, and 8:1. For example, under the situation of a scale of 1:1, the reference interval may be preset, and the controller 250 may set a reference interval according to the scale selected from among fixed scales, such as 2:1, 4:1, 6:1, and 8:1, based on the reference interval corresponding to a scale of 1:1.

The controller 250 controls the GUI 230 so that the zoom-in bar, which divides the set reference interval into fine adjustment intervals and magnifies the fine adjustment intervals, may appear on the display part 260. The reference interval contains a previous interval and a next interval within a predetermined range from the position of the content currently being played back, and may be set differently according to the magnification scale.

The magnification scale may be set to fixed scales, such as 1:1, 2:1, 4:1, 6:1, and 8:1, or an automatic scale. A user may set the magnification scale to at least one of the fixed scales and the automatic scale, and a reference interval corresponding to the automatic scale may be preset based on the total playback time of the content being played back.

Specifically, when a user operates magnification keys on the remote control device 300 or the manipulation part (not illustrated) to input the magnification command, the controller 250 may divide the reference interval corresponding to the set magnification scale by the preset interval adjustment value to determine fine adjustment intervals. Additionally, the controller 250 may control the GUI 230 to show the fine adjustment intervals as the display information on the display part 260.

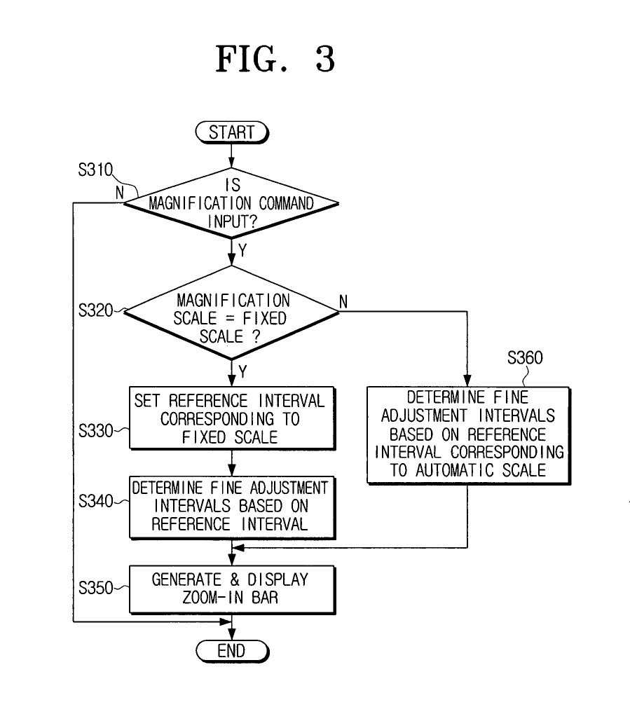

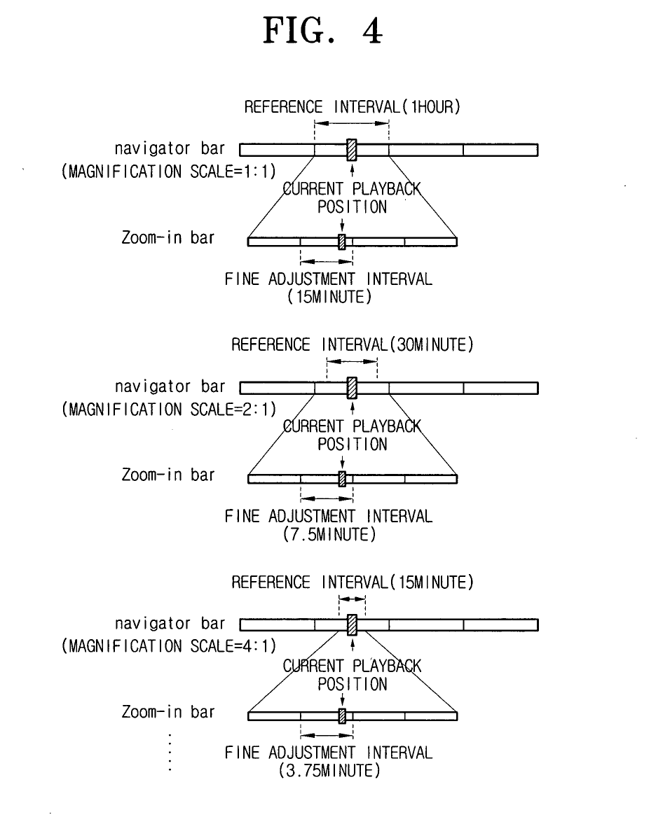

FIG. 3 is a flowchart explaining a method for operating an A/V apparatus according to an exemplary embodiment of the present invention. FIG. 4 is an exemplary view illustrating a zoom-in bar provided in an A/V apparatus according to exemplary embodiments of the present invention.

In FIGS. 3 and 4, when the magnification command is input through the remote control device 300 or the manipulation part (not illustrated) included in the A/V apparatus 200 in operation S310-Y, the controller 250 may determine whether the magnification scale is set to the fixed scale in operation S320. The magnification scale may be set by a user.

When it is determined that the magnification scale is set to the fixed scale, the controller 250 may set a reference interval according to the fixed scale, such as 2:1, 4:1, 6:1, and 8:1, in operation S330. The reference interval contains a previous interval and a next interval within a predetermined range from the position of the content currently being played back, and may be set differently according to the magnification scale.

Specifically, referring to FIG. 4, when the reference interval corresponding to a scale of 1:1 is set to 1 hour and the fixed scale is set to a scale of 2:1, the controller 250 may divide the reference interval corresponding to a scale of 1:1 by a scale of 2:1 to set a reference interval corresponding to a scale of 2:1 to 30 minutes. Additionally, when the magnification scale is set to a scale of 4:1, the controller 250 may divide the reference interval corresponding to a scale of 1:1 by a scale of 4:1 to set a reference interval corresponding to a scale of 4:1 to 15 minutes. In the same manner, the controller 250 may divide the reference interval corresponding to a scale of 1:1 by a scale of n:1, to set a reference interval corresponding to a scale of n:1.

Additionally, the controller 250 divides the set reference interval by the preset interval adjustment value to determine fine adjustment intervals in operation S340.

As shown in FIG. 4, if the interval adjustment value is set to a scale of 4:1 under the situation of a scale of 1:1, the controller 250 may divide the reference interval corresponding to 1 hour by the interval adjustment value of a scale of 4:1 to determine fine adjustment intervals. Each fine adjustment interval may correspond to 15 minutes. When the magnification scale is set to a scale of 2:1, the controller 250 may divide the reference interval of 30 minutes at a scale of 2:1 using the interval adjustment value of a scale of 4:1 to set the fine adjustment interval to be 7.5 minutes. In the same manner, the controller 250 may determine fine adjustment intervals corresponding to a scale of 1:1 to a scale of n:1.

Next, the controller 250 controls the GUI 230 so that the zoom-in bar, which divides the reference interval into the fine adjustment intervals and magnifies the fine adjustment intervals, may appear on the display part 260 in operation S350. The controller 250 permits the GUI 230 to combine the determined fine adjustment intervals with characters, symbols, diagrams, or graphics, to generate a zoom-in bar. The generated zoom-in bar may be displayed on the display part 260 in operation S350.

The controller 250 allows the navigation bar to appear translucent, displays the navigation bar on the display part 260, and controls the GUI 230 so that the zoom-in bar is not displayed on the display part 260 when a preset predetermined period of time elapses.

When it is determined that the magnification scale is set to the automatic scale in operation S320-N, the controller 250 may determine fine adjustment intervals using a preset reference interval corresponding to the automatic scale, and the interval adjustment value in operation S360.

Specifically, the controller 250 divides the reference interval corresponding to the automatic scale by the interval adjustment value to determine fine adjustment intervals. The reference interval corresponding to the automatic scale is preset based on the total playback time of the content.

The controller 250 permits the GUI 230 to combine the determined fine adjustment intervals with characters, symbols, diagrams, or graphics, to generate a zoom-in bar, and to display the generated zoom-in bar on the display part 260 in operation S350.

When a user controls the current playback position of the content being played back on the zoom-in bar, the controller 250 may display content corresponding to the controlled position on the display part 260. For example, when the current playback position of the content is 10, when a user desires to change the playback position to 25 and a position control command is input through the remote control device 300, the controller 250 may control the GUI 230 to display a graphic indicating the current playback position on the position controlled by the user, and to display content corresponding to the controlled position relative to the total content on the display part 260.

In the A/V apparatus and display method for the A/V apparatus according to the exemplary embodiments of the present invention, although the magnification command is received through the remote control device and the manipulation part included in the A/V apparatus, the present invention is not necessarily limited in this manner. The magnification command may be received through a selection from magnification icons or magnification menus displayed on the display part 260 by the GUI 230.

Additionally, in the A/V apparatus and display method for the A/V apparatus according to the exemplary embodiments of the present invention, the A/V apparatus provides the zoom-in bar to play back content. However, the present invention is not necessarily limited in this manner, and the zoom-in bar may be applied to all playback apparatuses capable of playing back content, such as digital televisions (TVs), camcorders, digital cameras, personal digital assistants (PDAs), personal computers (PCs), cellular phones, and other devices.

Furthermore, in the A/V apparatus and display method for the A/V apparatus according to the exemplary embodiments of the present invention, the navigation bar and zoom-in bar are displayed graphically in the form of a bar for convenience of the description. However, the present invention is not necessarily limited in this manner, and the navigation bar and zoom-in bar may be displayed graphically in the other forms.

As described above, according to the exemplary embodiment of the present invention, the zoom-in bar is provided so that a user may move the position of the content currently being played back to the desired position more accurately and quickly, and may perform fine adjustment with convenience using the zoom-in function.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

What is claimed is:

1. An A/V apparatus, comprising:
a graphical user interface (GUI) for displaying display information on a screen; and
a controller for controlling the GUI to display a second graphic, which is generated by zooming a partial interval of a first graphic indicating a current playback position, as the display information.

2. The apparatus as claimed in claim 1, wherein the controller controls the GUI to display the first graphic together with second graphic as the display information.

3. The apparatus as claimed in claim 1, wherein the controller determines fine adjustment intervals based on a reference interval corresponding to a set magnification scale, and controls the GUI to show the fine adjustment intervals as display information.

4. The apparatus as claimed in claim 3, wherein the controller sets a reference interval differently according to the magnification scale and determines the fine adjustment intervals based on the set reference interval.

5. The apparatus as claimed in claim 3, wherein the controller determines whether the magnification scale is set to a fixed scale when a magnification command is input through a remote control device; the controller sets a reference interval corresponding to the fixed scale by dividing a reference interval corresponding to a scale of 1:1 using the fixed scale and determines fine adjustment intervals based on the set reference interval when it is determined that the magnification scale is set to the fixed scale; and the controller determines the fine adjustment intervals using a preset reference interval corresponding to an automatic scale when it is determined that the magnification scale is set to the automatic scale.

6. The apparatus as claimed in claim 5, wherein the controller divides the set reference interval by a preset interval adjustment value to determine fine adjustment intervals when it is determined that the magnification scale is set to the fixed scale; and the controller divides the reference interval corresponding to the automatic scale by the interval adjustment value to determine fine adjustment intervals when it is determined that the magnification scale is set to the automatic scale.

7. The apparatus as claimed in claim 3, wherein the reference interval contains a previous interval and a next interval within a predetermined range from the position of the content currently being played back.

8. The apparatus as claimed in claim 3, wherein the controller controls the GUI so that the reference interval is magnified to show a plurality of fine adjustment intervals as display information.

9. A display method for an A/V apparatus, the method comprising:
displaying display information on a screen; and
displaying a second graphic, which is generated by zooming a partial interval of a first graphic indicating a current playback position, as the display information.

10. The method as claimed in claim 9, wherein the displaying the second graphic comprises displaying the first graphic together with second graphic as the display information.

11. The method as claimed in claim 9, wherein the displaying the second graphic comprises determining fine adjustment intervals based on a reference interval corresponding to a set magnification scale, and showing the fine adjustment intervals as display information.

12. The method as claimed in claim 11, wherein the displaying the second graphic comprises setting a reference interval differently according to the magnification scale and determining the fine adjustment intervals based on the set reference interval.

13. The method as claimed in claim 11, wherein the displaying the second graphic comprises:
determining whether the magnification scale is set to the fixed scale when a magnification command is input through a remote control device;
setting a reference interval corresponding to the fixed scale by dividing a reference interval corresponding to a scale of 1:1 using the fixed scale and determining fine adjustment intervals based on the set reference interval when it is determined that the magnification scale is set to the fixed scale; and
determining the fine adjustment intervals using a preset reference interval corresponding to an automatic scale when it is determined that the magnification scale is set to the automatic scale.

14. The method as claimed in claim 13, wherein the determining the fine adjustment intervals comprises:
dividing the set reference interval by a preset interval adjustment value to determine fine adjustment intervals when it is determined that the magnification scale is set to the fixed scale; and
dividing the reference interval corresponding to the automatic scale by the interval adjustment value to determine fine adjustment intervals when it is determined that the magnification scale is set to the automatic scale.

15. The method as claimed in claim 11, wherein the reference interval contains a previous interval and a next interval within a predetermined range from the position of the content currently being played back.

16. The method as claimed in claim 11, wherein the displaying the second graphic comprises magnifying the reference interval to show a plurality of fine adjustment intervals as display information.

17. A display method for an A/V apparatus, the method comprising:
displaying a second graphic on a screen as display information, the second graphic being generated by zooming a partial interval of a first graphic that indicates a current playback position.

18. The method as claimed in claim 17, the method comprising:
receiving a signal with a tuner;
processing the received signal to create an image;
displaying the image and the display information on the screen.

19. The method as claimed in claim 17, wherein the displaying the second graphic comprises displaying the first graphic together with second graphic as the display information.

20. The method as claimed in claim 17, wherein the displaying the second graphic comprises determining fine adjustment intervals based on a reference interval corresponding to a set magnification scale, and showing the fine adjustment intervals as display information.

21. The method as claimed in claim 20, wherein the displaying the second graphic comprises setting a reference interval differently according to the magnification scale and determining the fine adjustment intervals based on the set reference interval.

22. The method as claimed in claim 20, wherein the displaying the second graphic comprises:
determining whether the magnification scale is set to the fixed scale when a magnification command is input through a remote control device;
setting a reference interval corresponding to the fixed scale by dividing a reference interval corresponding to a scale of 1:1 using the fixed scale and determining fine adjustment intervals based on the set reference interval when it is determined that the magnification scale is set to the fixed scale; and
determining the fine adjustment intervals using a preset reference interval corresponding to an automatic scale when it is determined that the magnification scale is set to the automatic scale.

23. The method as claimed in claim 22, wherein the determining the fine adjustment intervals comprises:
dividing the set reference interval by a preset interval adjustment value to determine fine adjustment intervals when it is determined that the magnification scale is set to the fixed scale; and
dividing the reference interval corresponding to the automatic scale by the interval adjustment value to determine fine adjustment intervals when it is determined that the magnification scale is set to the automatic scale.

24. The method as claimed in claim 20, wherein the reference interval contains a previous interval and a next interval within a predetermined range from the position of the content currently being played back.

25. The method as claimed in claim 20, wherein the displaying the second graphic comprises magnifying the reference interval to show a plurality of fine adjustment intervals as display information.
